(19) United States
(12) Patent Application Publication
(10) Pub. No.: US 2009/0162564 A1
(43) Pub. Date: Jun. 25, 2009

(54) RADIATION CURABLE POLYURETHANE DISPERSIONS

(75) Inventors: Bryan Naderhoff, Durham, NC (US); Matt McAuliffe, Charlotte, NC (US); Shi Yang, Cary, NC (US); Michael B. Purvis, Fisherville, KY (US); Youichi Abe, Ichihara, Chiba (JP)

Correspondence Address: MYERS BIGEL SIBLEY & SAJOVEC, PO BOX 37428, RALEIGH, NC, 27627, US

(73) Assignee: Reichhold, Inc.

(21) Appl. No.: 12/396,121

(22) Filed: Mar. 2, 2009

Related U.S. Application Data
(63) Continuation of application No. 11/452,744, filed on Jun. 14, 2006.
(60) Provisional application No. 60/691,727, filed on Jun. 17, 2005.

(51) Int. Cl. C08F 2/48; C08G 18/08; B05D 3/10

(52) U.S. Cl. 427/508; 522/108; 524/591; 427/385.5

(57) ABSTRACT

A polyturethane dispersion is provided. The polyurethane dispersion includes 10 to 60 percent by weight of a polymeric polyol, 5 to 40 percent by weight of at least one compound containing both isocyanate reactive groups and meth(acrylate) groups wherein said compound comprises 1 to 30 percent by weight of at least one hydroxyl alkyl acrylate, 1 to 15 percent by weight of at least one compound comprising both isocyanate reactive groups and carboxyl groups, and 10 to 50 percent by weight of at least one isocyanate functional group.

### CROSS-REFERENCE TO RELATED APPLICATIONS

This application claims the benefit of, and incorporates herein by reference in its entirety, the following United States Provisional Application: U.S. Provisional Application No. 60/691,727, filed Jun. 17, 2005.

### FIELD OF INVENTION

The present invention relates to radiation curable aqueous polyurethane dispersions. Such dispersions can be used as a coating on a wide variety of substrates, such as plastic, metal and wood. The present invention also relates to methods for producing a radiation curable aqueous polyurethane dispersion.

### BACKGROUND OF INVENTION

Polyurethane dispersions have broad applications. They can be used to produce coatings on both nonflexible substrates, such as wood, and on flexible substrates, such as leather. Polyurethane dispersions are also gaining ever greater importance in building applications such as paints and varnishes, coatings, sealants and adhesives. In building applications, solvent-free polyurethane dispersions having a high solids content of polyurethane polymer or fillers, which can be made available by means of efficient and at the same time universal production processes, are particularly sought.

Conventional processes for preparing polyurethane dispersions suffer from various problems. These can include problems associated in the prepolymer mixing process, significant amounts of high-boiling and water-soluble solvents have been added to reduce the viscosity of the polyurethane prepolymers. These solvents remain in the polyurethane dispersion after the production process. When the polyurethane dispersions or the products produced therefrom are dried, these solvents are given off into the environment.

In some of the known solvent processes or acetone processes, the complete formation of the polyurethane polymers is carried out in the presence of large amounts of low-boiling and water-soluble solvents, for example acetone or methyl ethyl ketone. After the preparation of the polyurethane dispersion, the solvents have to be removed again by costly redistillation, so that the resulting polyurethane dispersions are largely solvent-free. The freedom from solvents and also the high solids contents, the excellent material properties and the small amounts of hydrophilic groups required for stabilizing the polyurethane dispersions are advantageous. However, the solvent process is a complicated and not generally economically optimal production process giving a low space-time yield, which can be disadvantageous. Additionally, there are also various combinations of prepolymer mixing process and solvent process, but these have similar problems.

More recently, there have been increasing efforts on the part of manufacturers of polyurethane dispersions to replace solvents such as N-methylpyrrolidone by ecologically acceptable glycol ethers which are not subject to labeling laws, for example dipropylene glycol dimethyl ether. However, such a change leads to an increase in costs in the prepolymer mixing process. Thus, a need exists for new types of polyurethane dispersions.

### SUMMARY OF THE INVENTION

The present invention relates to radiation curable aqueous polyurethane dispersions. The polyurethane dispersion can include a) 10 to 60 percent by weight of a polymeric polyol, b) compounds containing 5 to 40 percent by weight of isocyanate reactive groups and meth(acrylate) groups wherein said compound comprises 1 to 30 percent by weight of at least one hydroxyl alkyl acrylate, c) 1 to 15 percent by weight of a compound containing both isocyanate reactive groups and carboxyl groups, d) 10 to 50 percent by weight of isocyanate functional groups, and e) amine extender compounds containing 0.1 to 10 percent by weight, and optionally f) 0.1 to 10 percent by weight of at least one photoinitiator containing at least one isocyanate reactive group.

Such dispersions can be used as a coating on a wide variety of substrates, such as plastic, metal and wood. These coatings can be self-initiating and solvent free. Generally, the polyurethane dispersions of the present invention disclosure do not require a solvent. Instead they utilize a significantly lower amount of a diluent or no diluent at all. Reactive diluents can be used and can include acrylate monomers.

### DETAILED DESCRIPTION OF INVENTION

The present invention will now be described more fully hereinafter in which preferred embodiments of the invention are illustrated. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

Embodiments of the present invention can include polyurethane dispersions. These dispersions can be radiation curable aqueous dispersions. The polyurethane dispersion can include a) 10 to 60 percent by weight of a polymeric polyol, often 10 to 50 percent by weight, b) compounds containing 5 to 40 percent by weight of isocyanate reactive groups and meth(acrylate) groups wherein said compound comprises 1 to 30 percent by weight of at least one hydroxyl alkyl acrylate, c) 1 to 15 percent by weight of isocyanate reactive groups and carboxyl groups, d) 10 to 50 percent by weight of isocyanate functional groups, and optionally e) extender compounds containing 0.1 to 10 percent by weight of at least one amine compound, and/or optionally f) 0.1 to 10 percent by weight of at least one photoinitiator containing at least one isocyanate reactive group.

The dispersions of the invention are suitable for producing coatings on, for example, flexible and possibly absorbent substrates, such as paper, cardboard or leather, or inflexible substrates of metal or plastic. Thus, they can form a coating composition. They can be generally utilized for producing scratchproof and chemical-resistant finishes on wood.

The polymeric polyols used may include diols having 2 to 18 carbon atoms, generally 2 to 10 carbon atoms, such as 1,2-ethanediol, 1,3-propanediol, 1,4-butanediol, 1,6-hexanediol, 1,5-pentanediol, 1,10-decanediol, 2-methyl-1,3-propanediol, 2-methyl-2-butyl-1,3-propanediol, 2,2-dimethyl-1,3-propanediol, 2,2-dimethyl-1,4-butanediol, 2-ethyl-2-butyl-1,3-propanediol, neopentyl glycol hydroxypivalate, diethylene glycol and triethylene glycol. Triols and polyols of higher functionality include compounds having 3 to 25, generally 3 to 18, and, with more particularly, 3 to 6 carbon atoms. Examples of triols which can be used are glycerol or trimethylolpropane. As polyols of higher functionality it is possible, for example, to employ erythritol, pentaerythritol and sorbitol. Also suitable are low molecular mass reaction products of the polyols: for example, those of trimethylolpropane with alkylene oxides, such as ethylene oxide and/or propylene oxide. These low molecular mass polyols can be used individually or as mixtures.

Examples of suitable isocyanate reactive groups include the polycondensation products of α,β-ethylenically unsaturated mono- and/or dicarboxylic acids and their anhydrides with polyesterpolyols. Examples of α,β-ethylenically unsaturated mono- and/or dicarboxylic acids and their anhydrides which can be employed are acrylic acid, methacrylic acid, fumaric acid, maleic acid, maleic anhydride, crotonic acid, itaconic acid, etc. Generally, acrylic acid and methacrylic acid are employed. Polyesterols can be linear and/or branched polymers having terminal hydroxyl groups, examples being those having at least two hydroxyl end groups. The polyesterols can be simply prepared by esterifying aliphatic, cycloaliphatic and aromatic di-, tri- and/or polycarboxylic acids with di-, tri- and/or polyols. Examples of carboxylic acids include dicarboxylic acids having 2 to 20 carbon atoms, generally 4 to 15 carbon atoms, examples being malonic acid, succinic acid, adipic acid, glutaric acid, pimelic acid, suberic acid, sebacic acid, dodecanedioic acid, phthalic acid, terephthalic acid, isophthalic acid, cyclohexanedicarboxylic acid, etc. Also sulfosuccinic acid and sulfoisophthalic acid can be utilized. The dicarboxylic acids can be employed individually or as mixtures. Examples of diols include glycols, generally having 2 to 25 carbon atoms. Examples of glycols are 1,2-ethanediol, 1,3-propanediol, 1,4-butanediol, 1,5-pentanediol, 1,6-hexanediol, 1,10-decanediol, diethylene glycol, 2,2,4-trimethylpentane-1,5-diol, 2,2-dimethylpropane-1,3-diol, 1,4-dimethylolcyclohexane, 1,6-dimethylolcyclohexane and ethoxylated/propoxylated products of 2,2-bis(4-hydroxyphenyl)-propane (bisphenol A), etc. Triols and polyols have, for example, 3 to 25 carbon atoms, generally 3 to 18 carbon atoms. Examples include glycerol, trimethylolpropane, erythritol, pentaerythritol, sorbitol and their alkoxylates, etc. Polyesterols can also be prepared by polymerizing lactones: for example, lactones having 3 to 20 carbon atoms. Examples of suitable lactones for preparing the polyesterols are α,α-dimethyl-β-propiolactone, butyrolactone, caprolactone, etc.

Additionally isocyanates can include condensation products based on hydroxyl-containing esters of acrylic acid and/or methacrylic acid with at least one dihydric alcohol. Examples of hydroxyl-containing esters include 2-hydroxyethyl acrylate, 2-hydroxyethyl methacrylate, 2-hydroxypropyl acrylate, 2-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate, di(meth)acrylic esters of 1,1,1-trimethylolpropane or of glycerol. These hydroxyl-containing esters can be polycondensed with polyesterols having terminal carboxyl groups, or with the dicarboxylic acids and glycols which form these polyesterols, to give polyester acrylates.

Examples of isocyanates include the polycondensation products of the abovementioned α,β-ethylenically unsaturated mono- and/or dicarboxylic acids and their anhydrides with polyetherols. Polyetherols which can be employed can be linear or branched substances having terminal hydroxyl groups containing ether bonds and possessing a molecular weight in the range from, for example, about 500 to 10,000, generally from 600 to 5000. Suitable polyetherols can easily be prepared by polymerizing cyclic ethers such as tetrahydrofuran or by reacting one or more alkylene oxides having 2 to 4 carbon atoms in the alkyl radical with a starter molecule which contains two active hydrogen atoms bonded in the alkylene radical. Examples of alkylene oxides include ethylene oxide, 1,2-propylene oxide, epichlorohydrin, 1,2- and 2,3-butylene oxide. The alkylene oxides can be employed individually, alternately in succession or as a mixture. Examples of suitable starter molecules are water, the abovementioned glycols, polyesterols, triols and polyols, amines, such as ethylenediamine, hexamethylenediamine and 4,4′-diamino-diphenylmethane, and also amino alcohols, such as ethanolamine. Like the polyesterols, the polyetherols too can be used alone or in mixtures.

Examples of methacrylates include polyurethane acrylates include the polyaddition products of the polyisocyanates described below with the above-described hydroxyl-containing esters of acrylic and/or methacrylic acid with at least dihydric alcohols. Polyisocyanates can include diisocyanates, such as 2,4- and 2,6-tolylene diisocyanate (TDI) and isomer mixtures thereof, tetramethylxylylene diisocyanate (TMXDI), tetramethylene diisocyanate (TMDI), hexamethylene diisocyanate (HDI) and its trimers, norbornanediisocyanate (NBDI), isophorone diisocyanate (IPDI), trimethylhexamethylene diisocyanate (TMDI), dicyclohexylmethane diisocyanate (H₁₂ MDI), xylene diisocyanate (XDI) and diphenylmethane diisocyanate (MDI). Hydroxyl-containing esters of acrylic acid and/or methacrylic acid are the abovementioned hydroxyalkyl (meth)acrylates, generally hydroxymethyl acrylate, hydroxypropyl acrylate and hydroxyethyl methacrylate.

Examples of other methacrylates include epoxy acrylates which include the reaction products of diglycidyl ethers with the abovementioned α,β-ethylenically unsaturated mono- and/or dicarboxylic acids and their anhydrides. Acrylic acid and/or methacrylic acid are generally employed. Glycidyl ethers are obtained by reacting an alcohol component with an epoxy compound that has an appropriate leaving group in the position α to the epoxide group. Diglycidyl ethers are generally prepared from an aliphatic, cycloaliphatic or aromatic diol and epichlorohydrin as epoxy component. Aliphatic diols that can be used for preparing glycidyl ethers are the abovementioned glycols, generally 1,4-butanediol. Bisphenol A is generally employed as aromatic diol. Depending on the molar proportion of epoxy compound to diol component it is possible in this reaction to obtain either diglycidyl ethers or, with an increasing amount of diol, hydroxyl-containing diepoxides of higher molecular mass.

Polyester acrylates, polyether acrylates, polyurethane acrylates and epoxy acrylates are described, for example, in N. S. Allen, M. A. Johnson, P. Oldring (ed.) and M. S. Salim, Chemistry & Technology of UV&EB-Curing Formulations for Coatings, Inks & Paints, Vol. 2, SITA Technology, London 1991.

Amine extender compounds include compounds containing one or two amines include straight-chain and/or branched, aliphatic and cycloaliphatic amines having in general about 0 to 30 carbon atoms. Examples thereof include hydrazine ethylene diamine, 1,2-diaminopropane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 2-methyl-1,5-diaminopentane, piperazine, 1,2-cyclohexanediamine, 1,4-cyclohexanediamine, norbornadiamine, diethylenetriamine, triethylenetetramine, 4-azaheptamethylenediamine, N,N′-bis(3-aminopropyl)butane-1,4-diamine, and mixtures thereof. Suitable polyamines generally have a number-average molecular weight of from about 400 to 10,000. Examples of these include polyamides having terminal primary or secondary amino groups, polyalkylenimines, generally polyethylenimines, and vinylamines obtained by hydrolysis of poly-N-vinylamides, such as poly-N-vinylacetamide, and also α,diamines based on aminated polyalkylene oxides. Copolymers which contain α,β-,ethylenically unsaturated monomers with functional groups, examples being aminomethyl acrylate, aminoethyl acrylate, (N-methyl)aminoethyl acrylate, (N-methyl)aminoethyl methacrylate, etc., in copolymerized form, are also suitable for introducing photochemically or free-radically curable double bonds into the polyurethanes.

Examples of an isocyanate-reactive group include a hydroxyl group or a primary or secondary amino group. Other examples can include monofunctional alcohols, such as methanol, ethanol, n-propanol, isopropanol, etc. Other suitable components include amines having a primary or secondary amino group, such as methylamine, ethylamine, n-propylamine, isopropylamine, dimethylamine, diethylamine, di-n-propylamine, diisopropylamine, etc.

The polyurethanes in copolymerized form as component include at least one isocyanate functional group, such as a polyisocyanate, in a proportion of from about 10 to 50 percent by weight. Suitable polyisocyanates include compounds having 2 to 5 isocyanate groups, isocyanate prepolymers with an average number of from 2 to 5 isocyanate groups, and mixtures thereof. Examples of these include aliphatic, cycloaliphatic and aromatic di-, tri- and polyisocyanates. Examples of suitable diisocyanates include tetramethylene diisocyanate, hexamethylene diisocyanate, 2,3,3-trimethylhexamethylene diisocyanate, 1,4-cyclohexylene diisocyanate, isophorone diisocyanate, 1,4-phenylene diisocyanate, 2,4- and 2,6-tolylene diisocyanate and their isomer mixtures (e.g. 80 percent 2,4 and 20 percent 2,6 isomer), 1,5-naphthylene diisocyanate, 2,4- and 4,4′-diphenylmethane diisocyanate. Another example would include triisocyanate is triphenylmethane 4,4′,4″-triisocyanate. Also suitable are isocyanate prepolymers and polyisocyanates obtainable by addition of the abovementioned isocyanates onto polyfunctional hydroxyl- or amino-containing compounds. Polyisocyanates which result from biuret or isocyanurate formation are additionally suitable. Preference is generally given to the use of hexamethylene diisocyanate, trimerized hexamethylene diisocyanate, isophorone diisocyanate, 2,4-tolylene diisocyanate, 2,6-tolylene diisocyanate, and mixtures thereof.

The polyurethane dispersions of the invention are prepared by customary processes which are known to the skilled worker. These processes are described, for example, in Ullmann's Encyclopedia of Industrial Chemistry, 5th ed., Vol. A 21, VCH Weinheim, (1992), pp. 678-680. Examples include the spontaneous dispersion of polyurethane ionomers by the acetone process, prepolymer mixing processes, melt emulsion processes, etc. They also include the ketimine and ketazine process, and the dispersion of precursors, where hydrophilic oligomers are dispersed.

In the dispersion the molar proportion of isocyanate-reactive groups (a), (b) and (c) to equivalents of isocyanate groups of component (d) ranges from 0.8 to 1.1.

Embodiment of the present invention also include methods of producing a coating with a rapidly curing surface including preparing a curable coating composition by reacting or combining a) 0 to 60 percent by weight of a polymeric polyester polyol, b) 5 to 40 percent by weight of at least one compound containing both isocyanate reactive groups and meth(acrylate) groups wherein said compound comprises 1 to 30 percent by weight of at least one hydroxyl alkyl acrylate, c) 1 to 15 percent by weight of at least one compound comprising both isocyanate reactive groups and carboxyl groups, d) 10 to 50 percent by weight of at least one isocyanate functional group; and optionally e) 0.1 to 10 percent by weight of at least one amine extender compound; and optionally f) 0.1 to 10 percent by weight of at least one photoinitiator containing at least one isocyanate reactive group. This coating may also include a diluent. Examples of diluents include non-reactive solvents such as n-methyl pyrolidone (NMP) or reactive diluents such as conventional acylate monomers. Examples include trimethylol-propane triacrylate (TMPTA), tripropylene glycol diacrylate, or neopentyl glycol diacrylate (NPGDA). Other suitable diluents, due to their improved water miscibility and film coalescing properties, are (meth)acrylate monomers which are based on alkoxylated compounds. Examples are ethoxylated trimethylol propane triacrylate, propoxylated neopentyl glycol diacrylate, ethoxylated pentaerythritol tetraacrylate, ethoxylated Bisphenol A diacrylate, propoxylated glyceryl triacrylate, polyethylene glycol diacrylate, or polypropylene glycol diacrylate.

Embodiment of the present invention also include substrates formed by the method methods of producing a coating with a rapidly curing surface wherein the method also includes applying the curable coating composition to a substrate and curing the coating composition with radiation. Any type of radiation may be used such as ultraviolet radiation.

Such dispersions can be used as a coating on a wide variety of substrates, such as plastic, metal and wood. These coatings can be self-initiating and solvent free. Generally, the polyurethane dispersions of the present invention disclosure do not require a solvent. Instead they utilize a significantly lower amount of a diluent or no diluent at all. Examples of diluents include non-reactive solvents such as n-methyl pyrolidone (NMP) or reactive diluents such as conventional acylate monomers. Examples of reactive diluents include trimethylol-propane triacrylate (TMPTA), tripropylene glycol diacrylate, or neopentyl glycol diacrylate (NPGDA). Another class of reactive diluents which may be used due to their improved water miscibility and film coalescing properties, are (meth)acrylate monomers which are based on alkoxylated compounds. Examples are ethoxylated trimethylol propane triacrlate, propoxylated neopentyl glycol diacrylate, ethoxylated pentaerythritol tetraacrylate, ethoxylated Bisphenol A diacrylate, propoxylated glyceryl triacrylate, polyethylene glycol diacrylate, and polypropylene glycol diacrylate.

In the case of radiation-induced polymerization (UV, electron, X-ray or gamma radiation), UV curing is used the most often. UV curing is initiated in the presence of photoinitiators. Photoinitiators are, for example, can include aromatic ketone compounds, such as benzophenones, alkylbenzophenones, Michler's ketone, anthrone and halogenated benzophenones. Further suitable compounds are, for example, 2,4,6-trimethylbenzoyldiphenylphosphine oxide, phenylglyoxylic acid esters, anthraquinone and the derivatives thereof, benzil ketals and hydroxyalkylphenones. Other suitable compounds include photoinitiators which contain hydroxyl groups such as the chemical class alpha-hydroxylketones. Examples include 1-hydroxy-cyclohexyl-phenyl-ketone, 2-Hydroxy-2-methyl-1-phenyl-1-propanone, and 2-hydroxy-1-[4-(2-hydroxyethoxy) phenyl]-2-methyl-1-propanone. Mixtures of these compounds may also be used. Such photoinitiators often include a at least one isocyanate reactive group so that the photoinitiator can be incorporated directly into the isocyanate backbone

If curing proceeds by free radical means, water-soluble peroxides or aqueous emulsions of non water soluble initiators are suitable. These free radical formers may be combined with accelerators in a manner known to those of skill in the art.

The polyurethane dispersions according to the invention may be applied onto the most varied substrates by spraying, rolling, knife-coating, pouring, brushing or dipping. If the polyurethane dispersions according to the invention are applied onto wood, the resultant surfaces can be distinguished by particularly good optical properties. Other absorbent substrates such as paper, paperboard, leather and the like, as well as metals and plastics may also be coated with these dispersions.

The polyurethane dispersions according to the invention can also be used as the sole lacquer binder or they may be mixed or combined with binders, auxiliary substances and additives known in lacquer technology, such as for example dispersions, pigments, dyes or flatting agents.

Having now described the invention, the same will be illustrated with reference to certain examples, which are included herein for illustration purposes only, and which are not intended to be limiting of the invention.

### EXAMPLES

For the following examples the following information and abbreviations apply. Polyol 1 is a polyester polyol with an average hydroxyl equivalent weight of 468. It is commercially available as Desmophen® S1019-120 from Bayer Corp. EPAC 1 is the reaction product of liquid bisphenol A epoxy resin with acrylic acid. It is commercially available as Epotuf® 91-275 from Reichhold, Inc. and has an average hydroxyl equivalent weight of 257. HEA is hydroxy ethyl acrylate. NMP is n-methyl pyrolidone. HPA is hydroxy propyl acrylate. HPMA is hydroxy propyl methacrylate. DMPA is dimethylol propionic acid and has a molecular weight of 134. TPGDA is tripropylene glycol diacrylate, commercially available from Sartomer as SR-306. EO-TMPTA is the triacrylate of ethoxylated trimethylolpropane and is commercially available from Sartomer as SR-454. PO-NPGDA is the diacrylate of propoxylated neopentyl glycol and is commercially available as SR-9003 from Sartomer. Darocur 1173 is a photoinitiator available from Ciba Specialty Chemicals. Irgacur 2959 is a photoinitiator available from Ciba Specialty Chemicals. Irgacur 500 is a photoinitiator available from Ciba Specialty Chemicals. TEA is triethyl amine, and has a MW=101. IPDI is isophorone diisocyanate. It is available from Bayer as Desmodur I and has an isocyanate equivalent weight of 111. DETA is diethylene triamine. T-403 is a polypropylene oxide triamine with an average molecular weight of 403 which is available as Jeffamine T-403 from Huntsmen. MEHQ is monomethyl ether of hydroquinione, available from Eastman Chemical. T-12 is dibutyl tin dilaurate catalyst commercially available from Elf Atochem. DIW is deionized water.

### Examples 1-4

### Polyurethane Dispersions Using a Two Flask Process

General Procedure: Flask 1: Into a 1 liter glass reaction vessel equipped with stirring, temperature controller, and air sparge was charged Polyol 1, EPAC 1, DMPA, NMP or acrylate diluent, and MEHQ. The temperature was increased to 60-65 C and the IPDI was charged. The temperature was held at 55-70 C for approx. 1 hour, then the hydroxyl alkyl (meth)acrylate was charged and held at 55-70 C for approx. 1 hour and then the T-12 was charged. The reaction was held for approx. 140 minutes at 65-75 C. A sample was taken and the % NCO was measured. The TEA was then charged and allowed to mix for 15 minutes.

Flask 2: A second flask for the dispersion step was set up and the initial DIW was charged. The designated amount of the prepolymer from flask 1 was then transferred to flask 2 over approximately 5-10 minutes. The amine extender DETA or T-403 (premixed 10 percent in DIW) was then added to Flask 2 over 5-10 minutes. The flask 2 was mixed for approx. 1 hour, adjusted for viscosity with DIW, and then drained and analyzed. The following table illustrates these results.

TABLE 1
Examples 1-4. Formulations, Resin, and Coating Properties

| | Example # | | | |
|---|---|---|---|---|
| | 1 | 2 | 3 | 4 |
| Raw Material | | | | |
| Polyol 1 | 156 | 156 | 156 | 156 |
| EPAC 1 | 78 | 76 | 78 | 79 |
| DMPA | 27 | 27 | 30 | 29 |
| NMP | 90 | | | |
| TPGDA | | 90 | | |
| EO TMPTA | | | 110 | |
| PO NPGDA | | | | 90 |
| MEHQ | 0.24 | 0.24 | 0.24 | 0.24 |
| IPDI | 179 | 179 | 180 | 169 |
| T-12 | 0.12 | 0.12 | 0.12 | 0.22 |
| HEA | 59 | 59 | 60 | 50 |
| TEA | 20 | 20 | 22 | 21 |
| Resin transferred | 437 | 431 | 404 | 350 |
| DIW | 431 | 415 | 441 | 391 |
| DETA | 3.3 | 1.7 | | |
| T-403 | | | 4.4 | 4.4 |
| DIW (adjust viscosity) | | 94 | 20 | 58 |
| Resin Properties | | | | |
| % Solids | 41.5 | 40 | 45 | 39.7 |
| Viscosity, cps at 25 C. | 45 | 30 | 30 | 40 |
| Particle Size, microns | 0.1 | 0.062 | 0.056 | 0.032 |
| Stability, days at 120 F. | <4 | na | >66 | >60 |
| NCO: OH Index | 1.06 | 1.06 | 1.02 | 1.01 |
| % NCO of last sample | 2.3 | 0.48 | 1.8 | 1.7 |
| Acrylate Eq Wt, solids | 448 | 418 | 374 | 421 |
| Coating Properties | | | | |
| Photoinitiator Irgacure 500 | 5% | 5% | 5% | 5% |
| Cure Schedule, Hg Med | | | | |
| Pressure Lamp, 3 passes 20 | | | | |
| fpm @ 200 W/in, 1200 | | | | |
| mJ/cm² | | | | |
| Coating Appearance | Glossy | Poor | Glossy | Glossy |
| Adhesion to: Polycarbonate | 5B | na | 5B | 5B |
| PET | 5B | na | 5B | 5B |
| PMMA | 0B | na | 0B | 0B |
| TPO | 0B | na | 0B | 3-4B |
| MEK Double Rubs | 160 | na | >200 | >200 |
| Pencil Hardness on PMMA | HB | na | F | F |
| Stain Resistance | Good | Good | Good | Good |

### Examples 5-8

### Polyurethane Dispersions Using a One Flask Process

General Procedure: Into a 1 liter glass reaction vessel equipped with stirring, temperature controller, and air sparge was charged Polyol 1, EPAC 1, DMPA, PO-NPGDA, and MEHQ. The temperature was increased to 60-65° C. and the IPDI was charged. The temperature was held at 55-70° C. for approx. 1 hour, then the hydroxyl alkyl (meth) acrylate was charged and held at 55-70° C. for approx. 1 hour and then the T-12 was charged. The reaction was held for approx. 140 minutes at 65-75° C. A sample was taken and the % NCO was measured. The TEA was then charged and allowed to mix for 15 minutes. The initial DIW was charged to the flask over approx. 30 minutes. The amine extender, T-403 (premixed 10 percent in DIW) was then added over 5-10 minutes. The dispersions was mixed for approx. 1 hour, adjusted for viscosity with DIW, and then drained and analyzed. The following table illustrates these results.

TABLE 2
Examples 5-8 Formulations, Resin, and Coating Properties

| | Example # | | | |
|---|---|---|---|---|
| | 5 | 6 | 7 | 8 |
| Raw Material | | | | |
| Polyol 1 | — | 125 | 92 | 92 |
| EPAC 1 | 93 | | 46 | 46 |
| Irgacure 2959 | — | | | 17 |
| Darocur 1173 | | | 17 | |
| DMPA | 17 | 17 | 17 | 17 |
| PO NPGDA | 53 | 53 | 53 | 53 |
| MEHQ | 0.14 | 0.14 | 0.14 | 0.14 |
| IPDI | 100 | 100 | 100 | 100 |
| T-12 | 0.08 | 0.08 | 0.08 | 0.08 |
| HPMA | 36 | | | |
| HPA | | 55.2 | | |
| HEA | | | 30.4 | 24 |
| TEA | 11 | 11 | 11 | 11 |
| DIW | 361 | 394 | 391 | 391 |
| T-403 | 4.4 | 4.4 | 4.4 | 4.4 |
| DIW (adjust viscosity) | 174 | 0 | 0 | 0 |
| Resin Properties | | | | |
| % Solids | 34.5 | 44.6 | 44.7 | 45.8 |
| Viscosity, cps at 25 C. | 70 | 20 | 30 | 50 |
| Particle Size, microns | 0.076 | 0.52 | 0.18 | 0.12 |
| Stability, days at 120 F. | >61 | 7 | 33 < 60 | >49 |
| NCO: OH Index | 1.04 | 0.91 | 0.92 | 0.94 |
| % NCO of last. sample | 2.1 | 1.1 | 1.3 | 2.1 |
| Acrylate Eq Wt, solids | 332 | 462 | 445 | 445 |
| Coating Properties | | | | |
| Irgacure 500 Added | 5% | 5% | None | None |
| Cure Schedule, Hg Mad | | | | |
| Pressure Lamp, 3 passes 20 | | | | |
| fpm @ 200 W/in, 1200 | | | | |
| mJ/cm² | | | | |
| Coating Appearance | Glossy | Glossy | Glossy | Glossy |
| Adhesion to: Polycarbonate | 4B | 5B | 5B | 5B |
| PET | 5B | 5B | 5B | 5B |
| PMMA | 5B | 0B | 0B | 0B |
| TPO | 08 | 0B | 0B | 0B |
| MEK Double Rubs | 110 | 51 | >200 | 195 |
| Pencil Hardness on PMMA | F | F | F | HB |
| Stain Resistance | Ex | Good | Ex | Good |

The following table illustrates the degree of cure versus means of incorporating the photoinitiator.

TABLE 3

| | Example # | | |
|---|---|---|---|
| | 4 | 7 | 8 |
| Photoinitiator | 5% Irgacure 500 | 5% Darocur 1173 | 5% Irgacure |
| | | | 2959 |
| PI added in: | Coating | PUD prepolymer | PUD |
| | | | prepolymer |
| UV Cure Conditions | Hg Mad Pressure Lamp, 20fpm @ 200 W/in, | | |
| | 1200 mJ/cm² | | |
| MEK DR's after X | | | |
| passes | | | |
| 1 pass | 35 | 90 | 110 |
| 2 pass | 71 | 130 | 155 |
| 3 pass | >200 | >200 | 195 |

### Example 9

Three different polyurethane dispersion compositions were produced using a diluent of either n-methyl pyrolidone (NMP), ethoxylated trimethylol-propane triacrylate (EO-TMPTA), or propoxylated neopentyl glycol diacrylate (PO-NPGDA). Additionally a photoinitiator was used in this dispersion. The EO-TMPTA and the PO-NPGDA both illustrated better results than the NMP for the MEK double rub test. The MEK double rub test is a standardized method used in the coatings industry known as, “Standard Test Method for Measuring MEK Resistance of Ethyl Silicate (Inorganic) Zinc-Rich Primers by Solvent Rub. See, ASTM D4752-03, “Measuring MEK Resistance of Ethyl Silicate (Inorganic) Zinc-Rich Primers by Solvent Rub”, (West Conshohocken, Pa.: Annual Book of ASTM: 2003). The EO-TMPTA and the PO-NPGDA both illustrated better results than the NMP for pencil harness on PMMA as well.

The foregoing examples are illustrative of the present invention and are not to be construed as limiting thereof. The invention is defined by the following claims, with equivalents of the claims to be included therein.

1. A polyurethane dispersion comprising:
a) 10 to 60 percent by weight of a polymeric polyol;
b) 5 to 40 percent by weight of at least one compound containing both isocyanate reactive groups and meth(acrylate) groups wherein said compound comprises 1 to 30 percent by weight of at least one hydroxyl alkyl acrylate;
c) 1 to 15 percent by weight of at least one compound comprising both isocyanate reactive groups and carboxyl groups; and
d) 10 to 50 percent by weight of at least one isocyanate functional group, wherein the dispersion is free of non-reactive organic solvents and non-reactive diluents.

2. The polyurethane dispersion of claim 1, further comprising:
a) 0.1 to 10 percent by weight of at least one amine extender compound; and
b) 0.1 to 10 percent by weight of at least one photoinitiator containing at least one isocyanate reactive group.

3. The polyurethane dispersion of claim 1, further comprising a reactive diluent.

4. The polyurethane dispersion of claim 3, wherein the reactive diluent is a (meth)acrylate of an alkoxylated compound.

5. The polyurethane dispersion of claim 1, wherein said dispersion is in the form of an aqueous dispersion.

6. The polyurethane dispersion of claim 1, wherein the ratio of isocyanate group equivalents of croups (a), (b) and (c) to equivalents of isocyanate-reactive groups of component (d) is 0.8:1.1.

7. A coating composition comprising at least one polyurethane dispersion of claim 1.

8. A substrate comprising the coating composition of claim 7.

9. An aqueous polyurethane dispersion comprising:
a) 10 to 60 percent by weight of a polymeric polyol;
b) 5 to 40 percent by weight of at least one compound containing both isocyanate reactive groups and meth(acrylate) groups wherein said compound comprises 1 to 30 percent by weight of at least one hydroxyl alkyl acrylate;
c) 1 to 15 percent by weight of at least one compound comprising both isocyanate reactive groups and carboxyl groups;
d) 10 to 50 percent by weight of at least one isocyanate functional group; and
e) 0.1 to 10 percent by weight of at least one photoinitiator bonded to the backbone of the at least one isocyanate functional group, wherein the dispersion is free of non-reactive organic solvents and non-reactive diluents.

10. The aqueous polyurethane dispersion according to claim 9 further comprising 0.1 to 10 percent by weight of at least one amine extender compound.

11. The aqueous polyurethane dispersion of claim 9, further comprising a reactive diluent.

12. The aqueous polyurethane dispersion of claim 11, wherein the reactive diluent is a (meth)acrylate of an alkoxylated compound.

13. The dispersion of claim 11, wherein the reactive diluent is the diacrylate of propoxylated neopentyl glycol.

14. The dispersion of claim 9, wherein the ratio of isocyanate group equivalents of groups (a), (b) and (c) to equivalents of isocyanate-reactive groups of component (d) is 0.8:1.1.

15. A method of coating a substrate with a rapidly curing surface comprising:
a) forming a curable coating composition comprising 10 to 60 percent by weight of a polymeric polyol, 5 to 40 percent by weight of at least one compound containing both isocyanate reactive groups and meth(acrylate) groups wherein said compound comprises 1 to 30 percent by weight of at least one hydroxyl alkyl acrylate, 1 to 15 percent by weight of at least one compound comprising both isocyanate reactive groups and carboxyl groups, and 10 to 50 percent by weight of at least one isocyanate functional group, wherein the curable coating composition is formed without the use of non-reactive solvents and non-reactive diluents,
b) applying the coating composition to a substrate, and
c) curing the coating composition.

16. The method according to claim 15, further comprising a reactive diluent.

17. The method according to claim 16, wherein the reactive diluent is a (meth)acrylate of an alkoxylated compound.

18. The method according to claim 15, wherein said step of curing is done using radiation.
